(19) United States
(12) Patent Application Publication
(10) Pub. No.: US 2011/0305452 A1
(43) Pub. Date: Dec. 15, 2011

(54) OPTICAL SIGNAL DETECTING DEVICE AND OPTICAL SIGNAL DETECTION METHOD

(75) Inventor: Akihiro Tosaki, Tokyo (JP)

(73) Assignee: NEC Corporation, Tokyo (JP)

(21) Appl. No.: 13/138,478

(22) PCT Filed: Mar. 15, 2010
(86) PCT No.: PCT/JP2010/054748

§ 371 Date: Aug. 24, 2011

(30) Foreign Application Priority Data
Mar. 25, 2009 (JP) 2009-073503

(51) Int. Cl. H04B 10/08; H04J 14/02

(52) U.S. Cl. 398/34; 398/25

(57) ABSTRACT

An optical signal detecting device and an optical signal detection method which can detect true signal strength from a signal including a noise are provided.

Therefore, an optical signal detecting device according to the present invention includes: at least two filter means, each of the filter means receiving an identical optical signal, having a transmission peak at a specific wavelength different from each other and having same after-pass noise intensity; a detection means for detecting output light intensity of each of the filter means; and a calculating means for calculating signal strength of a signal component of said optical signal based on said output light intensity detected by said detection means.

### TECHNICAL FIELD

This invention relates to an optical signal detecting device and an optical signal detection method.

### BACKGROUND ART

There are two prominent methods of optical channel monitors (OCM: Optical Channel Monitor), that is, a monochromator method and a polychromator method.

The monochromator method performs wavelength sweeping by rotating a grating (diffraction grating) equipped in it. On this occasion, light is received by a photodetector. As a result, the monochromator method can monitor an optical level in each wavelength of incident light. Meanwhile, a photodetector (light detector) is equipped with a photodiode which is a sensor.

Because of its structure, this monochromator method requires a reference light source outside in order to correct an aging change of an optical filter and to secure wavelength accuracy. Moreover, because this monochromator method takes time to perform wavelength sweeping, there is a drawback that it takes much time to collect data.

On the other hand, the polychromator method allocates a plurality of photodetectors in the demultiplex side of a wavelength demultiplexer such as a diffraction grating, and detects light by each detector. As a result, the polychromator method can monitor an optical level in each wavelength of the incident light.

Because data collection is performed simultaneously by using a plurality of photodetectors, this polychromator method is fast. On the other side, the polychromator method needs to increase the resolution in order to distinguish between an optical signal component and an ASE (Amplified Spontaneous Emission: spontaneous emission light) component. As a result, in order to increase the resolution, the polychromator method comes to have a larger number of photodetectors than the number of channels that are to be detected. Consequently, the polychromator method has a problem that the cost of parts increases.

An example of an OCM of the polychromator method is described in Japanese Patent Application Laid-Open No. 2008-219616 (patent document 1). The OCM shown in FIG. 6 of the patent document 1 includes an optical switch 30, an AWG (Arrayed Waveguide Grating) 20 and a PD (Photo Diode) array module 50 having a PD array 54 of 8 channels built-in in it.
Patent document 1: Japanese Patent Application Laid-Open No. 2008-219616

### DISCLOSURE OF THE INVENTION

### Problems to be Solved by the Invention

The OCM described in patent document 1 detects the optical power itself of each wavelength by the PD array module 50. Such optical power itself includes a noise that is the above-mentioned ASE component. For this reason, there is a risk that a signal having strength comparable with that of the noise cannot be distinguished from the noise. Therefore, in the OCM described in said patent document 1, there is a risk of false detection.

An object of the present invention is to provide an optical signal detecting device and an optical signal detection method which can settle the above-mentioned problem, and detect true signal strength from a signal including a noise.

### Means for Solving the Problem

In order to achieve the above-mentioned object, an optical signal detecting device of the present invention includes: at least two filter means, each of the filter means receiving an identical optical signal, having a transmission peak at a specific wavelength different from each other and having same after-pass noise intensity; a detection means for detecting output light intensity of each of the filter means; and a calculating means for calculating signal strength of a signal component of the optical signal based on the output light intensity detected by the detector.

Also, an optical signal detecting device of the present invention includes: an optical switch means for switching a route of an inputted optical signal to one of two routes; an arrayed waveguide diffraction grating means, comprising respective incident waveguides connected to the two routes and a slab waveguide connected so that incident positions or incident angles from the incident waveguides are different from each other, for performing wavelength separation from an optical signal inputted from the route; a detection means for converting an optical signal from the arrayed waveguide diffraction grating means into an electric signal; and a calculating means for calculating signal strength from an electric signal made by converting an optical signal passing through one of the incident waveguides by the detector and an electric signal made by converting the identical optical signal passing through an other one of the incident waveguides by the detection means.

An optical signal detection method of the present invention includes: a first detecting step for detecting strength of an optical signal having been made pass through a filter, the filter having a transmission peak at a specific wavelength and having same after-pass noise intensity; a second detecting step for detecting strength of the optical signal having been made pass through another filter, said another filter having a transmission peak at a specific wavelength different from the specific wavelength of the filter and having same after-pass noise intensity; and an operation step for calculating signal strength from output light intensity detected by the first detecting step and the second detecting step.

Further, an optical signal detection method of the present invention includes: a route switching step for switching a route to one of two routes; a wavelength separation step for performing wavelength separation of an optical signal from the route by a slab waveguide connected to the two routes and set so that incident positions or incident angles from the two routes are different from each other; a conversion step for converting an optical signal wavelength-separated by the wavelength separation step into an electric signal; and an operation step for calculating signal strength from an electric signal made by conversion in the conversion step after passing through one of the routes and an electric signal made by conversion in the conversion step after passing through an other one of the routes.

### ADVANTAGES OF THE INVENTION

According to the present invention, because signal strength is obtained by calculation, true signal strength which is obtained by removing a noise from detected power light intensity is obtained.

### BRIEF DESCRIPTION OF THE DRAWINGS

FIG. 1 is an explanatory drawing showing a summary of an optical signal detecting device, of a first exemplary embodiment.

FIG. 2 is an explanatory drawing showing a summary of an optical signal detecting device of a second exemplary embodiment.

FIG. 3 is an explanatory drawing showing an optical signal detection process of a third exemplary embodiment.

FIG. 4 is an explanatory drawing showing an optical signal detection process of a fourth exemplary embodiment.

FIG. 5 is a block diagram showing an optical signal detecting device of a fifth exemplary embodiment.

FIG. 6 is a circuit configuration diagram showing an AWG of an optical signal detecting device of the fifth exemplary embodiment.

FIG. 7 is a block diagram showing a transmission line in a WDM system.

FIG. 8 is an explanatory drawing showing the characteristics of an optical input signal and an optical output signal at the time when an optical signal is entered in an amplifier.

FIG. 9A is an explanatory drawing showing an example of AWG transmission characteristics when selecting a first port.

FIG. 9B is an explanatory drawing showing an example of AWG transmission characteristics when selecting a second port.

FIG. 10 is an explanatory drawing showing AWG transmission characteristics and an example of an optical signal in the fifth exemplary embodiment.

FIG. 11A is an example of AWG transmission characteristics and an optical signal when selecting the first port in the fifth exemplary embodiment.

FIG. 11B is an example of AWG transmission characteristics and an optical signal when selecting the second port in the fifth exemplary embodiment.

### EXEMPLARY EMBODIMENTS

Next, the present invention will be described with the exemplary embodiments.

### The First Exemplary Embodiment

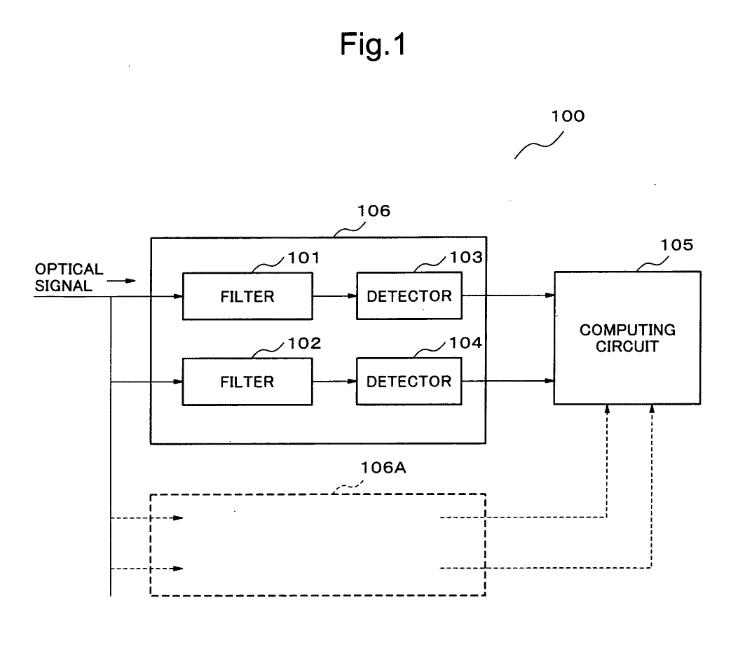

The first exemplary embodiment of the present invention will be described based on FIG. 1.

FIG. 1 is an explanatory drawing showing an outline of an optical signal detecting device of the first exemplary embodiment.

An optical signal detecting device 100 shown in FIG. 1 includes a filter 101, a filter 102, a detector 103, a detector 104 and a computing circuit 105.

A same optical signal is inputted into the filters 101 and 102. The filter 101 is an optical filter that has a transmission peak at a specific wavelength and has same noise intensity after pass. The filter 102 is an optical filter that has a transmission peak at a specific wavelength different from that of the filter 101, and has the same noise intensity after pass like the filter 101. These filters 101 and 102 correspond to a filter means.

The detectors 103 and 104 detect intensity of lights output from each of the filters 101 and 102. These detectors 103 and 104 can use, for example, a PD (Photo diode) which detects intensity of lights by converting it into an electric signal. The detectors 103 and 104 correspond to a detection means.

The computing circuit 105 calculates signal strength of the signal component of the optical signal based on the intensity of output lights (intensity of the optical signal) detected by the detectors 103 and 104. Here, the intensity of the output lights detected by the detectors 103 and 104 includes signal component and a noise component, but the noise component is constant. Therefore, as an example, by carrying out an operation of obtaining a difference between intensities of signal lights, the signal strength of the signal component after removing the noise component can be calculated. The computing circuit 105 corresponds to a calculating means.

In this way, because signal strength is calculated, the optical signal detecting device 100 can obtain true signal strength by which the noise is removed from detected intensity of the output light. For this reason, the optical signal detecting device 100 can make possibility of false detection of the optical signal small, even when the strength of the signal component of the optical signal is equal to that of the noise.

Meanwhile, in the case where detection of signal strengths of a plurality of wavelengths is performed, a plurality of units 106A and so on similar to the unit 106 are arranged to calculate signal strengths of the plurality of wavelengths. Although not illustrated, two filters and two detectors are included in the unit 106A. However, the filters of this unit 106A are optical filters each having a transmission peak at a specific wavelength different from those of the filters 101 and 102.

### The Second Exemplary Embodiment

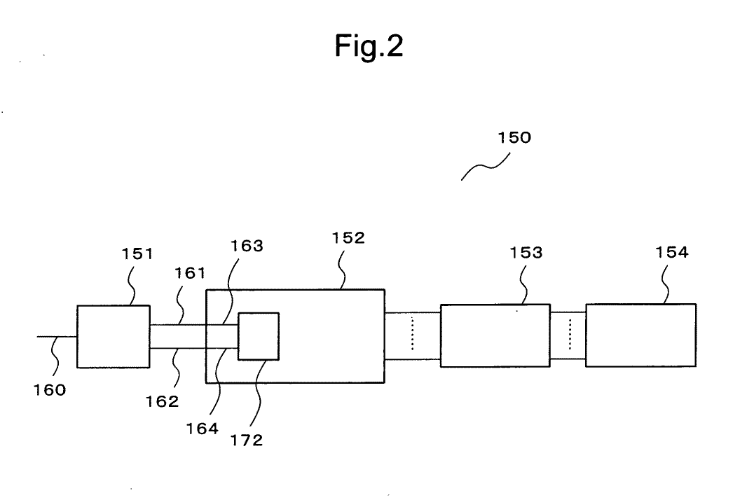

Next, the second exemplary embodiment of the present invention will be described based on FIG. 2.

FIG. 1 is an explanatory drawing showing an outline of an optical signal detecting device of the second exemplary embodiment.

An optical signal detecting device 150 shown in FIG. 1 includes an optical switch 151, an AWG 152, a detector 153 and a computing circuit 154. The above-mentioned AWG is an arrayed waveguide diffraction grating (Arrayed Waveguide Grating) and corresponds to an arrayed waveguide diffraction grating means.

The optical switch 151 changes an input route 160 of an inputted optical signal to one of two output paths (output paths 161 and 162). Then, the optical switch 151 corresponds to an optical switch means.

The AWG 152 includes incident waveguides 163 and 164 which are two input routes for the optical signal outputted from the optical switch 151 and a slab waveguide 172 arranged in the incident side. The incident waveguides 163 and 164 are connected to the output paths 161 and 162.

The slab waveguide 172 is connected to both of the incident waveguides 163 and 164 such that the incident positions from the incident waveguides 163 and 164 are different. Further, instead of connecting such that the incident positions are different, connecting such that the incident angles are different can be applied. Because it is publicly known that diffraction in the slab waveguide 172 differs according to setting of incident positions or incident angles to the slab waveguide 172 in the incident side, the detailed description will be omitted. When the diffraction in the slab waveguide 172 is changed, transmission characteristics and transmission spectra in the AWG 152 are changed.

The detector 153 receives a signal from the AWG 152. The detector 153 can be used, for example, a PD (Photo Diode) array, and corresponds to a detection means.

The computing circuit 154 calculates strength of an optical signal output from the optical switch 151 based on a signal output from the detector 153. Specifically, this calculation is a calculation of an operation to obtain the signal strength of a signal component from one electric signal and the other electric signal. The one electric signal is an electric signal obtained by that the optical signal is converted in the detector 153 after passing through one incident waveguide 163. The other electric signal is an electric signal obtained by that the optical signal is converted in the detector 153 after passing through one incident waveguide 164. Meanwhile, the computing circuit 154 corresponds to a calculating means.

In the thus constituted optical signal detecting device 150, first, the optical switch 151 switches the route of an inputted optical signal to, for example, the output path 161. Next, the AWG 152 receives the optical signal from the one output path 161 of the optical switch 151, and performs wavelength separation of the inputted optical signal. The detector 153 converts the optical signal inputted from the AWG 152 into an electric signal (one electric signal) and outputs it to the computing circuit 154 in the latter stage.

Next, the optical switch 151 switches the route of the inputted identical optical signal to the output path 162. Then, the AWG 152 receives an optical signal from one output path 162 of the optical switch 151, and performs wavelength separation of the inputted optical signal. The detector 153 converts the optical signal inputted from the AWG 152 into an electric signal (the other electric signal) and outputs it to the computing circuit 154 in the latter stage.

The computing circuit 154 calculates signal strength from the one electric signal and the other electric signal. As a specific example of calculation, calculation by obtaining a difference between a plurality of pieces of strength of an optical signal detected by a detector, or calculation by solving simultaneous equations having signal strength of the signal component of an optical signal as a variable (refer to the fifth exemplary embodiment described later) is cited.

Thus, according to this exemplary embodiment, because signal strength is obtained by calculation, true signal strength made by removing a noise in an optical signal is obtained.

### The Third Exemplary Embodiment

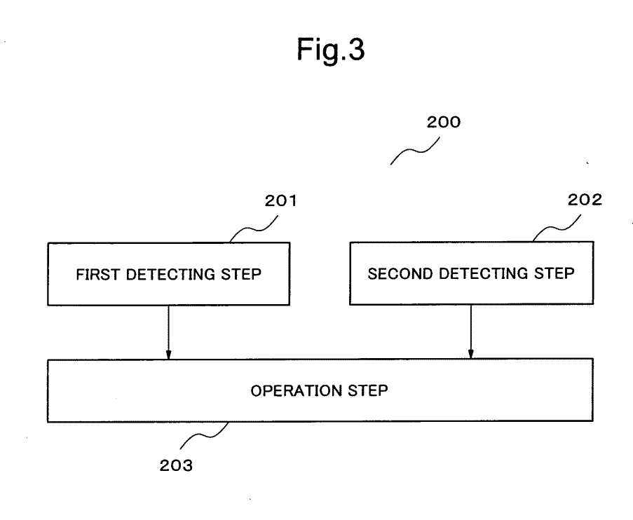

Next, the third exemplary embodiment of the present invention will be described based on FIG. 3.

FIG. 3 is an explanatory drawing showing an optical signal detection method of the third exemplary embodiment.

This optical signal detection method 200 includes a first detecting step 201, a second detecting step 202 and an operation step 203.

The first detecting step 201 is a step for detecting strength of an optical signal after passing a filter, which has a transmission peak at a specific wavelength and same noise intensity after pass.

The second detecting step 202 is a step for detecting strength of an optical signal after passing a filter, which has a transmission peak at a specific wavelength different from the specific wavelength of the aforementioned filter and the same noise intensity after pass.

The operation step 203 is a step for calculating signal strength from output light intensity detected by the first detecting step 201 and the second detecting step 202.

In the optical signal detection method 200 having such steps, first, in the first detecting step 201, strength of an optical signal after passing a filter, which has a transmission peak at a specific wavelength and same noise intensity after pass, is detected.

Next, in the second detecting step 202, strength of the optical signal after passing a filter, which has a transmission peak at a specific wavelength different from the specific wavelength of the aforementioned filter and the same noise intensity after pass, is detected.

Then, in the operation step 203, signal strength is calculated from the strength of the optical signal detected by the first detecting step 201 and the second detecting step 202. This calculations is calculation by obtaining a difference or calculation by solving simultaneous equations (refer to the fifth after-mentioned exemplary embodiment mentioned later) like the first exemplary embodiment and the second exemplary embodiment, for example.

Thus, according to this optical signal detection method 200, because signal strength of the signal component is calculated by an operation, true signal strength made by removing a noise in an optical signal is obtained.

### The Fourth Exemplary Embodiment

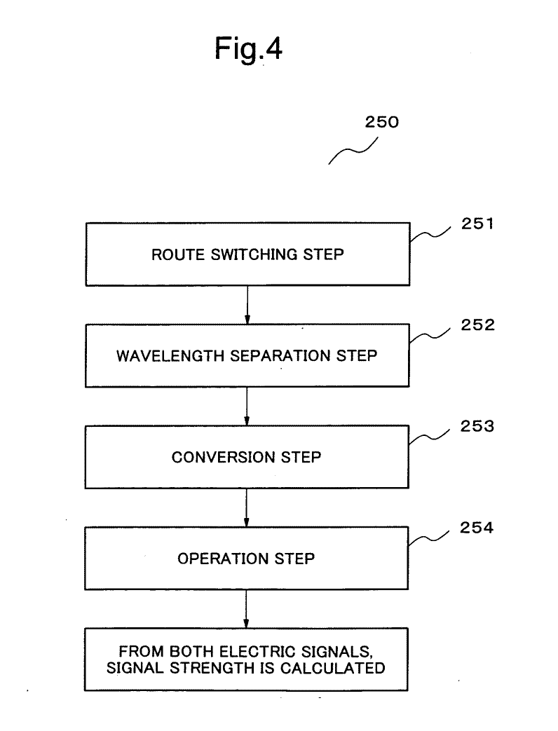

Next, the fourth exemplary embodiment of the present invention will be described based on FIG. 4.

FIG. 2 is an explanatory drawing showing an optical signal detection method of the fourth exemplary embodiment of the present invention.

This optical signal detection method 250 includes a route switching step 251, a wavelength separation step 252, a conversion step 253 and an operation step 254.

The route switching step 251 switches a route of an optical signal to one of two routes. The above optical signal 310 is, for example, a wavelength division multiplexing (WDM: Wavelength Division Multiplexing) signal.

The wavelength separation step 252 performs a wavelength separation of an optical signal inputted from the routes by a slab waveguide which is connected to the above-mentioned two routes and in which incident positions from these routes are different from each other. Meanwhile, it can be applied that incident angles to the slab waveguide are different from each other.

The conversion step 253 converts the optical signal whose wavelength has been separated in the wavelength separation step 252 into an electric signal. The operation step 254 calculates signal strength from one electric signal and the other electric signal. The one electric signal is an electric signal made in a way that the optical signal passes one of the routes, wavelength separation is performed to it by the wavelength separation step 252 and, further, it is converted by the conversion step 253. The other electric signal is an electric signal made in a way that the identical optical signal passes the other route, wavelength separation is performed to it by the wavelength separation step 252 and, further, it is converted by the conversion step 253. Meanwhile, the calculation is calculation by obtaining a difference or calculation by solving simultaneous equations like the third exemplary embodiment.

In the optical signal detection method 250 having such steps, first, the route of an optical signal is switched to one of the routes by the route switching step 251. Next, by the wavelength separation step 252, wavelength separation is performed to the optical signal from the above-mentioned one route using diffraction phenomenon of the slab waveguide. Then, by the conversion step 253, the optical signal to which wavelength separation has been performed is converted into an electric signal (one electric signal).

Next, by the route switching step 251, the route of the optical signal is switched to the other route. Next, by the wavelength separation step 252, wavelength separation is performed to the optical signal from the above-mentioned the other route using diffraction phenomenon of the slab waveguide. On this occasion, because the slab waveguides are set such that the incident positions of the optical signal are different, diffraction will be different from that of the optical signal through the one route. For this reason, the transmission characteristics are different and thus the transmission spectrum is shifted. Then, by the conversion step 253, the optical signal whose wavelength separation has been performed is converted into an electric signal (other electric signal).

Finally, by the operation step 254, signal strength is calculated from the one electric signal and the other electric signal. As a result, the true signal strength made by removing a noise from the output light intensity can be obtained.

### The Fifth Exemplary Embodiment

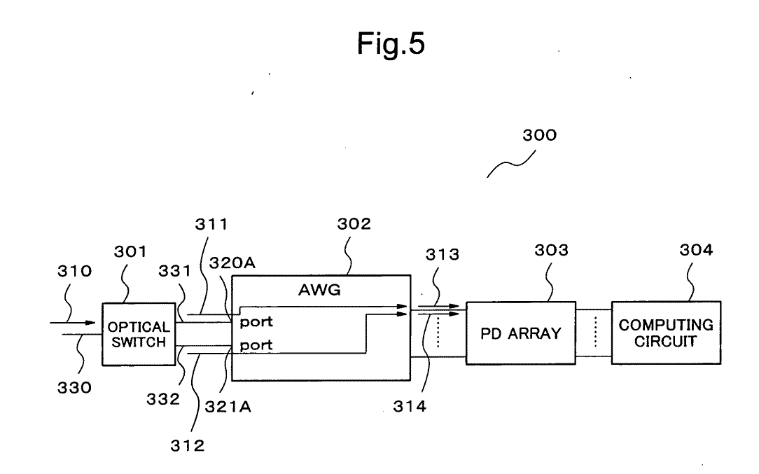

Next, the fifth exemplary embodiment of the present invention will be described based on FIGS. 5 to 11B.

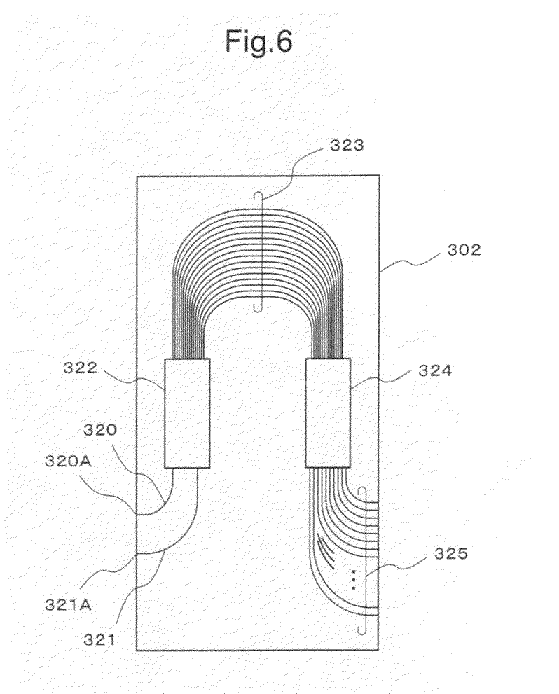

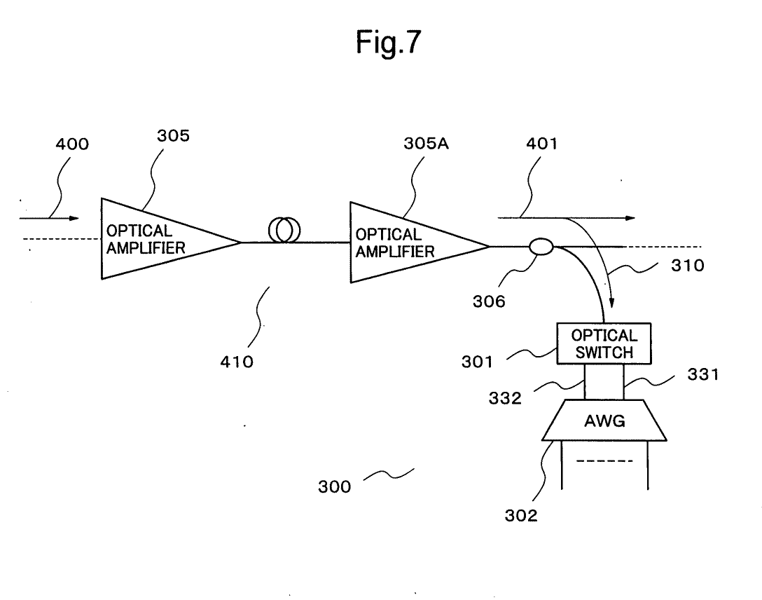

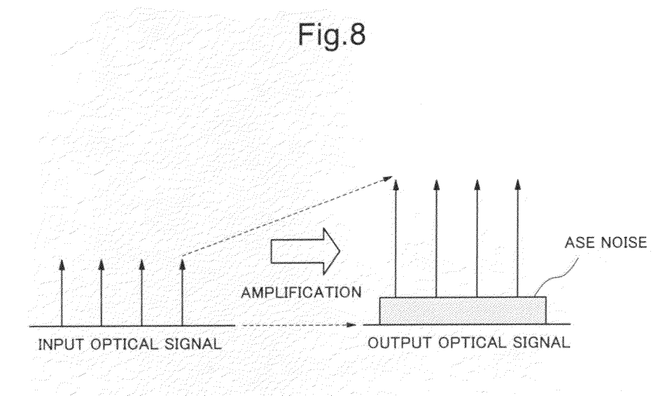

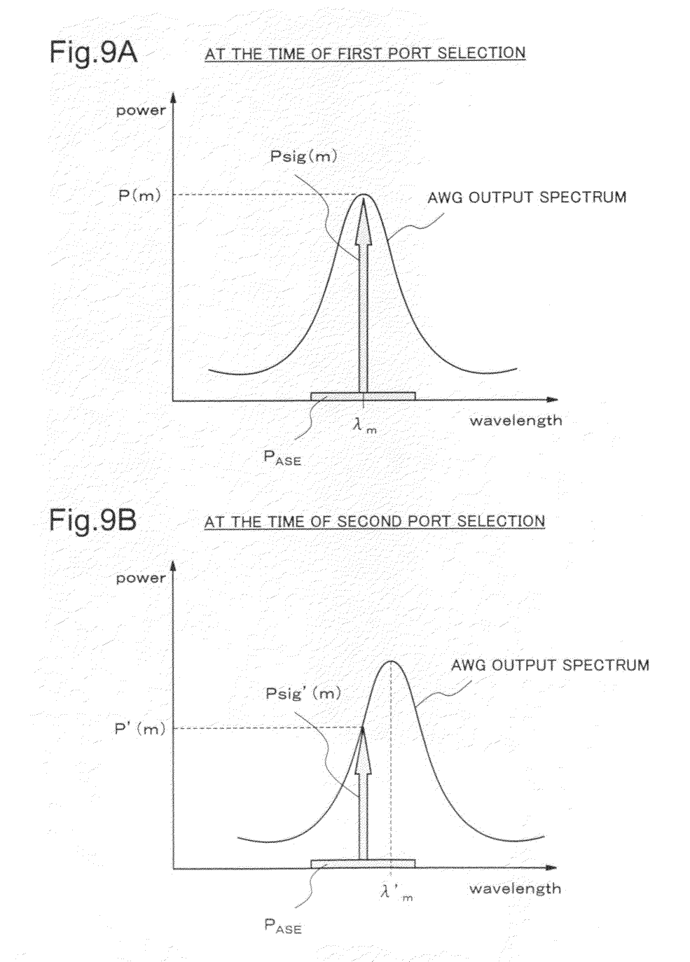

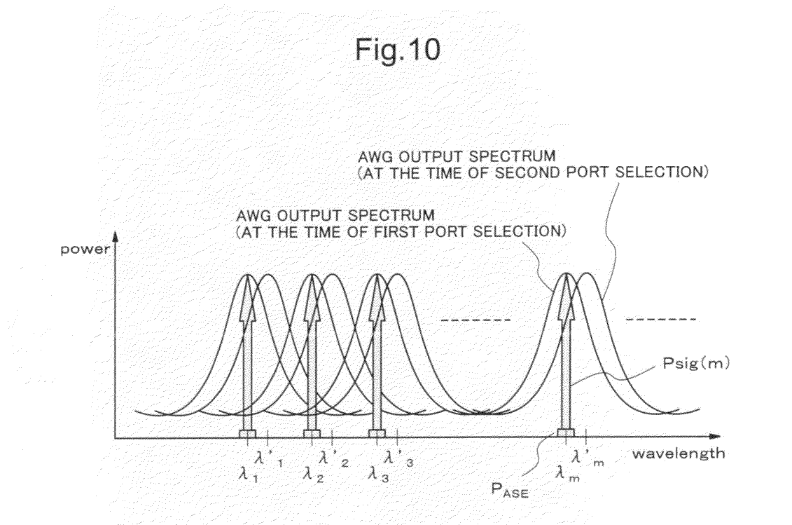

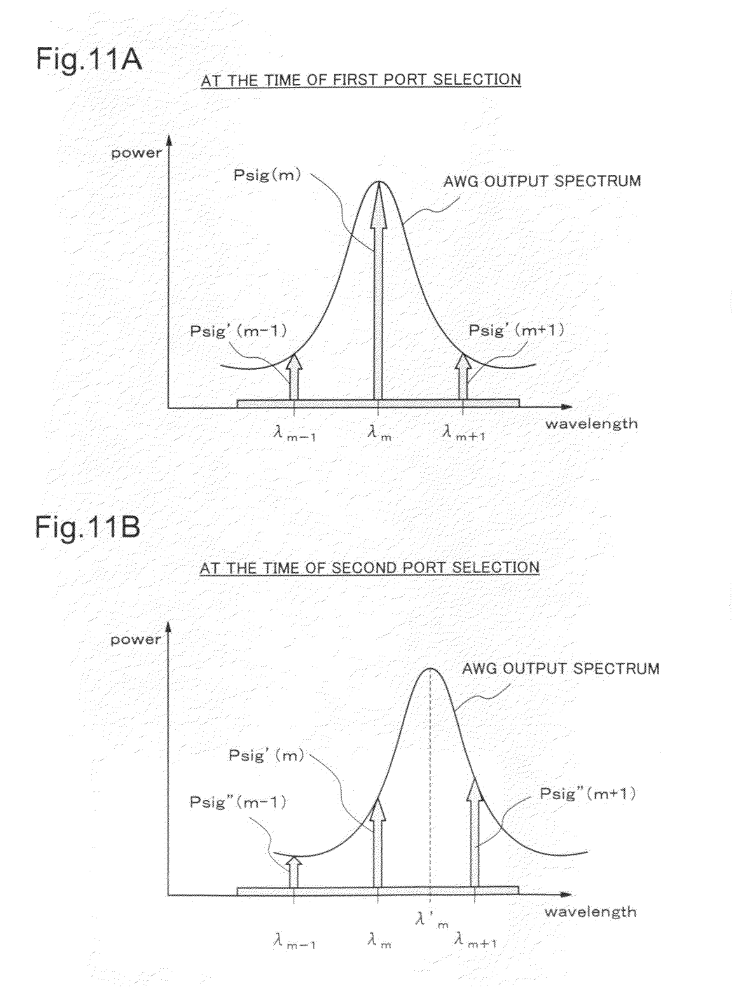

FIG. 5 is a block diagram showing an optical signal detecting device of the fifth exemplary embodiment. FIG. 6 is a circuit configuration diagram showing an AWG of an optical signal detecting device of the fifth exemplary embodiment. FIG. 7 is a block diagram showing a transmission line in a WDM system. FIG. 8 is an explanatory drawing showing characteristics of an optical input/output signal at the time when an optical signal is entered into an amplifier. FIG. 9A is an explantory drawing showing an example of AWG transmission characteristics when selecting a first port. FIG. 9B is an explanatory drawing showing an example of AWG transmission characteristics when selecting a second port. FIG. 10 is an explanatory drawing showing AWG transmission characteristics and an example of an optical signal in the fifth exemplary embodiment. FIG. 11A is AWG transmission characteristics and an example of an optical signal in the fifth exemplary embodiment when selecting the first port. FIG. 11B is AWG transmission characteristics and an example of an optical signal in the fifth exemplary embodiment when selecting the second port.

An optical switch 301 uses a switch called a 1×2 optical switch. This optical switch 301 includes a single input route 330 and two output paths 331 and 332, and it is an optical switch means that switches an output route to one of the output paths 331 and 332. This optical switch 301 is arranged in the stage before an AWG 302. As a result, the optical switch 301 has the function to output the optical signal 310, which is obtained from a monitor output (not shown) of a transmission apparatus, into each port of the AWG 302 in a switching manner. Meanwhile, the above-mentioned optical signal 310 is a wavelength division multiplexing (WDM) signal. The AWG 302 corresponds to an arrayed waveguide diffraction grating means.

As this optical switch 301, an optical switch such as a PLC type, an optical fiber type, a bubble type and a MEMS type can be used, for example. The above-mentioned PLC is a planer optical waveguide circuit (Planar Lightwave Circuit). The above-mentioned MEMS is a microelectromechanical system (Micro Electro Mechanical System). Further, the optical switch 301 is not limited to a switch of these forms, and other forms besides these can be used.

An optical signal 311 flows through an output path 331 and an optical signal 312 flows through an output path 332. These optical signals 311 and 312 are wavelength division multiplex signals like the optical signal 310.

Switching of the optical switch 301 is performed 10 ms after a computing circuit 304 receives a signal from a PD array 303. When this time period is secured, strength detection of the optical signal is possible. Moreover, when a different optical signal is inputted and the computing circuit 304 receives the signal from the PD array 303, it is preferred that the optical switch 301 is switched to detect the optical signal 10 ms after the signal inputs.

The PD array 303 is a detector which converts optical signals (such as optical signals 313 and 314) from the AWG 302 into an electric signal and corresponds to a detection means. Then, the PD array 303 includes a plurality of PDs (Photo Diodes).

The computing circuit 304 is arranged in the stage after the PD array 303. The computing circuit 304 is a calculating means for calculating signal strength of an optical signal outputted from the optical switch 301 based on an output signal of the PD array 303.

The AWG 302 shown in FIG. 6 includes a first port 320A and a second port 321A as input ports for incident waveguides 320 and 321. Moreover, the AWG 302 further includes an incident side slab waveguide 322, an arrayed waveguides 323, an emission side slab waveguide 324 and emission waveguides 325 as many as the number of wavelengths which should be detected. Meanwhile, when an optical transmission path (channel) of 16 wavelengths is supposed, the number of the arrayed waveguides 323 is 16 as shown in FIG. 6. Then, when an optical transmission path (channel) of 40 wavelengths is supposed, the number of the arrayed waveguides 323 will be 40. The number of the arrayed waveguide 323 and the emission waveguides 325 will be the same.

When an optical multiplexed signal in which a plurality of wavelengths is multiplexed is entered to the incident waveguide 320, it is spread by diffraction in the incident side slab waveguide 322 and is emitted into the arrayed waveguide 323. The arrayed waveguide 323 includes a plurality of waveguides, and its neighboring waveguides are arranged with a certain optical path difference. Therefore, at the output end of the arrayed waveguide 323, phase differences are caused in the optical signals. The optical signals which have passed the arrayed waveguide 323 are propagated by the emission side slab waveguide 324 and spread by diffraction. The optical signals interfere with each other and strengthen each other only in a direction that wavefronts are aligned. By providing the emission waveguides 325 at every positions of the outgoing part of the emission side slab waveguide 324, optical signals each having different wavelength can be taken out.

The connecting location of the incident waveguide 320 with the incident side slab waveguide 322 and the connecting location of the incident waveguide 321 with the incident side slab waveguide 322 are arranged in different positions. Alternatively, it can be arranged such that the incident angle of an optical signal from the incident waveguide 320 and the incident angle of an optical signal from the incident waveguide 321 are different from each other. By this, different diffraction is observed in the incident side slab waveguide 322, and as a result, transmission characteristics and transmission spectra of the AWG 302 will differ. So, the center wavelength of the transmission spectrum of an optical signal which enters to the second port 321A and is emitted from the emission waveguides 325 shifts from that of the optical signal which is inputted from the first port 320A and is emitted from the emission waveguides 325.

As a result, when identical white light is inputted from each of the first port 320A and the second port 321A, the center wavelengths of the transmission spectra from the emission waveguides 325 are different from each other.

In the PD array 303, there are arranged photodiodes (PD) as many as the number of wavelengths which should be detected. By that an optical signal separated by the AWG 302 is irradiated to the PD array 303, the amount of received light for each spectrally separated wavelength can be detected by the PD array 303.

The structure of the PD array 303 is not limited to a multichannel PD array. For example, in the case of a 40-wave transmission model, 40 single-channel PDs may be used.

The computing circuit 304 performs AD (analog-digital) conversion after converting a photo electric current outputted from the PD array 303 into a voltage. Moreover, the computing circuit 304 performs predetermined data processing in order to separate a signal component and a noise component from light received by the PD array 303, and outputs the signal component as a result. The separation of a noise component by the computing circuit 304 is calculated by an operation which eliminates the noise component. This calculation is a calculation which solves simultaneous equations as mentioned later, for example.

Next, details about the strength calculation method of the optical signal of the optical signal detecting device 300 of this exemplary embodiment will be described using FIG. 7, FIG. 8, FIG. 9A and FIG. 9B.

As shown in FIG. 7, a wavelength division multiplex signal (optical signal 400) in which a plurality of different wavelengths are bundled together is transmitted by an optical fiber transmission path 410 in a WDM system. As shown in FIG. 8, when an input optical signal is amplified by an optical amplifier 305 and an optical amplifier 305A, an amplified spontaneous emission light noise (hereinafter, referred to as an ASE noise) is added to an output optical signal due to the characteristics of an amplifier. In this exemplary embodiment, ASE noise power is described as PASE.

An optical signal 401 (a wavelength division multiplex signal) which has passed through the optical fiber transmission path 410 and to which an ASE noise has been added is dichotomized in an optical coupler 306 for use as monitor output of the transmission line. One of the branched optical signals is inputted to the optical switch 301. By its switching operation, the optical switch 301 switches the route to one of the output paths 331 and 332.

First, it is supposed that, by switching the optical switch 301, the output path has been switched so that output is directed to the first port 320A of the AWG 302. Receiving light power of a PD for the optical signal 311 when this first port 320A is selected is described as P (m) in this explanation.

Next, it is supposed that, by switching the optical switch 301, the output path has been changed such that output is directed to the second port 321A of the AWG 302. Receiving light power of a PD for the optical signal 312 when this second port 321A is selected is described as P′ (m) in this explanation. Here, m is the number of the PD placed corresponding to each of the emission waveguides 325 of the AWG 302.

As described above, the waveforms of an AWG 302 output spectrum in identical PD when the first port 320A is selected and when the second port 321A is selected are different from each other, as shown in FIG. 9A and FIG. 9B.

As shown in FIG. 9A, the transmission characteristic of an optical signal to be monitored is maximized when the first port 320A is selected. When the transmission characteristic is set so that the center wavelength of a transmission spectrum of the AWG 302 is the same as the wavelength of the optical signal, and the transmission characteristic is set so that the center wavelength of a transmission spectrum shifts by about 20 GHz at the time when second port 321A is selected, output from the PD at the time of second port 321A selection is different from that of at the time of first port 320A selection. This is because the transmission characteristic of an optical signal that is inputted to the first port 320A and emitted from the emission waveguides 325 is different from that of the optical signal that is inputted to the second port 321A and emitted from the emission waveguides 325. On the other hand, as shown in FIG. 9A and FIG. 9B, because an ASE noise has almost no wavelength dependency within the pass band of the AWG 302, there are no changes in detection power due to a selected port. This will be expressed by the following formula (1) and formula (2).

P(m)=Psig(m)+PASE(m) Formula (1)

P′(m)=Psig′(m)+PASE(m) Formula (2)

Here, Psig (m) and Psig′ (m) are power strengths of an optical signal component of P (m) and P′ (m), and PASE (m) is power strength of an ASE noise component. In the meantime, as a premise, the wavelength of the optical signal is only one wave in this description.

The amount of the difference between the center wavelengths of the AWG output spectra is (λ′m−λm), and the signal power is influenced according to this amount of difference between these center wavelengths. For this reason, relation between Psig (m) and Psig′ (m) will be such that Psig (m): Psig′ (m)=1: a (λ′m−λm). From this relation, there is a relation of the next formula (3) between Psig (m) and Psig′ (m).

Psig′(m)=α(λ′m−λm)×Psig(m) Formula (3)

Here, α (λ) is a transmission spectrum function of the AWG 302, and, in particular, is a function in which λ which is a parameter is shifted so that it becomes equal to a difference amount from the center wavelength. For this reason, the parameter λ becomes a difference amount from the center wavelength. λm is a center wavelength of an optical signal which passes the AWG 302 when the first port 320A is selected, and λ′m is a center wavelength of the optical signal which passes the AWG 302, when the second port 321A is selected. Therefore, the shift amount of the center wavelengths between the first port 320A and the second port 321A decided by design will be (λ′m−λm).

Using by the formula (1), (2) and (3), the following formula (4) is calculated. Specifically, first, the left-hand side of the formula (2) is subtracted from the left-hand side of the formula (1), and the right-hand side of the formula (2) is subtracted from the right-hand side of the formula (1). Next, by substituting the formula (3) for the item of Psig′ (m) of the right-hand side, the following formula (4) is calculated.

P(m)−P′(m)=(1−α(λ′m−λm))×Psig(m) Formula (4)

When Psig (m) is obtained from the formula (4), the following formula (5) is calculated.

Psig(m)=(P(m)−P′(m))/(1−α(λ′m−λm)) Formula (5)

As shown by the formula (5), just a signal component without power strength PASE (m) of an ASE noise can be calculated.

Next, as shown in FIG. 10, FIG. 11A and FIG. 11B, when a plurality of wavelengths of optical signal 310 (wavelength division multiplex signal) are inputted, P (m) and P′ (m) which are receiving light power output of PDs for the optical signals 311 and 312 are expressed by the next formula (6) and formula (7).

According to this exemplary embodiment, it is supposed that, only the transmission characteristic of the AWG 302 is considered, but the influence of an optical signal away from the wavelength (λm) by two wavelengths (λm+2, λm−2) or more is not considered because it is weak. However, in a case when the AWG 302 with a wide transmission bandwidth is used or when the interval between signals becomes small, it needs to be considered. For this reason, in an optical detecting device different from that of this exemplary embodiment, an optical signal which is distant by two wavelengths or more may be considered.

Also, because, as is shown before, an ASE noise has almost no wavelength dependency within the pass band of the AWG 302, and thus there are no changes in power detected by a selected port (the first port 320A or the second port 321A), it can be supposed that PASE is constant. Therefore, the following formula (6) and formula (7) can be held.

P(m)=Psig(m)+Psig′(m−1)+Psig′(m+1)+PASE(m) Formula (6)

P′(m)=Psig′(m)+Psig″(m−1)+Psig″(m+1)+PASE(m) Formula (7)

Among Psig′ (m−1), Psig′ (m+1), Psig (m−1) and Psig (m+1), there is relation shown by the following formula (8) and formula (9). Psig″ (m−1) and Psig″ (m+1) are the signal strengths (receiving light powers output of the PD) of signal components caused by Psig′ (m) against a neighboring wavelength. Consequently, they affect the signal powers by the difference between center wavelengths when the second port is selected, and thus the following formula (10) and formula (11) can be held.

Psig′(m−1)=α(λm−λm−1)×Psig(m−1) Formula (8)

Psig′(m+1)=α(λm+1−λm)×Psig(m+1) Formula (9)

Psig″(m−1)=α(λ′m−λm−1)×Psig(m−1) Formula (10)

Psig″(m+1)=α(λm+1−λ′m)×Psig(m+1) Formula (11)

(m) and P′ (m) can be calculated like the following formulas (12) and (13) from the formulas (3) and (6)-(11). Specifically, when substituting the formula (8) and the formula (9) for the formula (6), the formula (12) can be calculated. Also, when substituting the formula (10) and the formula (11) for the formula (7), the formula (13) can be calculated.

P(m)=α(λm−λm−1)×Psig(m−1)+Psig(m)+α(λm+1−λm)×Psig(m+1)+PASE(m) Formula (12)

P′(m)=α(λ′m−λm−1)×Psig(m−1)+α(λ′m−λm)×Psig(m)+α(λm+1−λ′m)×Psig(m+1)+PASE(m) Formula (13)

When an optical signal is not detected in an adjacent wavelength of the wavelength concerned, respective terms of Psig (m−1) and Psig (m+1) of the formula (12) and (13) is 0, and thus Psig (m) can be calculated from these formulas (12) and (13). That is, the formula (12) and the formula (13) become the next formulas (12-1) and (13-1), respectively, and Psig (m) can be calculated from these two formulas. Therefore, in the case of 40 wavelengths, by substituting 1-40 for m, Psig (1)-Psig (40) can be calculated. Here, as P (1)-P (40) and P′ (1)-P′ (40), detected numerical values are used. Also, PASE (m) (PASE (1)=PASE (2m)= . . . =PASE (40)) is constant.

P(m)=Psig(m)+PASE(m) Formula (12-1)

P′(m)=α(λ′m−λm)×Psig(m)+PASE(m) Formula (13-1)

However, when an optical signal is detected in the adjacent wavelength of the wavelength concerned, 40 simultaneous equations in which 1-40 are substituted for m are used because m is a numerical value of 1-40 for 40 wavelengths. Also, for the formula (13), the formula when m=1 is used. On this occasion, there are 41 kinds of variables of Psig (1)-Psig (40) and PASE (m) (PASE (1)=PASE (2)= . . . =PASE (40)), and thus there are 40 kinds of values, Psig (1)-Psig (40), to be calculated. Meanwhile, Psig (0) and Psig (41) are 0.

When m=1, the formulas (12) and (13) are as follows.

P(1)=α(λ1−λ0)×Psig(0)+Psig(1)+α(λ2−λ1)×Psig(2)+PASE(1)

Therefore,

P(1)=Psig(1)+α(λ2−λ1)×Psig(2)+PASE(1) Formula (12-2)

P′(1)=α(λ′1−λ0)×Psig(0)+α(λ′1−λ1)×Psig(1)+α(λ2−λ′1)×Psig(2)+PASE(1)

Therefore,

P′(1)=α(λ′1−λ1)×Psig(1)+α(λ2−λ′1)×Psig(2)+PASE(1) Formula (13-2)

Psig (1)-Psig (40) can be calculated from these two formulas (12-2) and (13-2) and 39 kinds of formulas of the formula (12) when making m=2 to 40.

Meanwhile, regarding an AWG with input ports of not less than 3, the above-mentioned simultaneous equations does not hold, and thus it is not related to this exemplary embodiment.

That is, by the computing circuit 304 carrying out calculation for solving the formula (12) and the formula (13) that are applied to all PDs, signal strength of each CH made by removing a noise can be obtained.

According to this exemplary embodiment, because it is a polychromator method, the PD array 303 that is a component of high speed reading can be used. For this reason, in the optical signal detecting device 300 of this exemplary embodiment, the data collection time is short and calculation of noise-removed signal strength can catch up with the reception speed of an optical signal.

According to this exemplary embodiment, it is possible to make the number of photodiodes used in a PD array be the same as the number of channels that should be detected, or be the number corresponding to the number of wavelengths. So, the number of PDs can be reduced compared with a polychromator OCM described in the column of Background Art, and thus the optical signal detecting device 300 can be made inexpensive.

According to the exemplary embodiment, because signal strength is obtained by calculation, true strength which is made by removing a noise in an optical signal is obtained. As a result, the risk of false detection of light intensity can be reduced.

Although the present invention has been described with reference to the exemplary embodiments above, the present invention is not limited to these exemplary embodiments. Various changes which a person skilled in the art can understand can be made to the composition and details of the present invention within the scope of the present invention.

This application claims priority based on Japanese application Japanese Patent Application No. 2009-073503, filed on Mar. 25, 2009, the disclosure of which is incorporated herein in its entirety.

### INDUSTRIAL APPLICABILITY

An optical signal detecting device according to the present invention can be applied to an apparatus for calculating signal strength and obtaining true signal strength which is made by removing a noise from detected output light intensity. Therefore, an optical signal detecting device according to the present invention can be applied to optical communication and the like.

### DESCRIPTION OF SYMBOLS

100, 150 and 300 Optical signal detecting device
101 and 102 Filter
103, 104 and 153 Detector
105, 154 and 304 Computing circuit
106 and 106A Unit
151 and 301 Optical switch
152 and 302 AWG
160 and 330 Input route
161, 162, 331 and 332 Output path
163, 164, 320 and 321 Incident waveguide
172 Slab waveguide
200 and 250 Optical signal detection method
201 First detecting step
202 Second detecting step
203 and 254 Operation step
251 Route switching step
252 Wavelength separation step
253 Conversion step
303 PD array
305 and 305A Optical amplifier
306 Optical coupler
310 or 311, 312 or 313, 314 and 400 or 401 Optical signal
320A First port
321A Second port
322 Incident side slab waveguide
323 Arrayed waveguide
324 Emission side slab waveguide
325 Emission waveguide
410 Optical fiber transmission path

1-10. (canceled)

11. An optical signal detecting device, comprising:
at least two filters, each of which receives an identical optical signal, has a transmission peak at a specific wavelength different from each other and has same after-pass noise intensity;
a detection part which detects output light intensity of each of said filters; and
a calculating part which calculates signal strength of a signal component of said optical signal based on said output light intensity detected by said detection part.

12. The optical signal detecting device according to claim 11, wherein
said calculating part performs a calculation to obtain a difference between a plurality of pieces of strength of said detected optical signal or a calculation to solve simultaneous equations having signal strength of a signal component of an optical signal as a variable.

13. The optical signal detecting device according to claim 11, wherein said inputted optical signal comprises a wavelength division multiplex signal.

14. The optical signal detecting device according to claim 11, wherein said detection part comprises a PD (Photo Diode) array.

15. An optical signal detecting device, comprising:
an optical switch which switches a route of an inputted optical signal to one of two routes;
an arrayed waveguide diffraction grating which comprises respective incident waveguides connected to said two routes and a slab waveguide connected so that incident positions or incident angles from said incident waveguides are different from each other, and performs wavelength separation from an optical signal inputted from said route;
a detection part which converts an optical signal from said arrayed waveguide diffraction grating into an electric signal; and
a calculating part which calculates signal strength from an electric signal made by converting an optical signal passing through one of said incident waveguides by said detector and an electric signal made by converting said identical optical signal passing through an other one of said incident waveguides by said detection part.

16. The optical signal detecting device according to claim 15, wherein
said calculating part performs a calculation to obtain a difference between a plurality of pieces of strength of said detected optical signal or a calculation to solve simultaneous equations having signal strength of a signal component of an optical signal as a variable.

17. The optical signal detecting device according to claim 15, wherein said inputted optical signal comprises a wavelength division multiplex signal.

18. The optical signal detecting device according to claim 15, wherein
said detection part comprises a PD (Photo Diode) array.

19. The optical signal detecting device according to claim 15, wherein
said optical switch comprises any one of a PLC (Planar Lightwave Circuit) switch, an optical fiber type switch, a bubble type switch and a MEMS (Micro Electro Mechanical Systems) type switch.

20. An optical signal detection method, comprising:
a first detecting for detecting strength of an optical signal having been made pass through a filter, said filter having a transmission peak at a specific wavelength and having same after-pass noise intensity;
a second detecting for detecting strength of said optical signal having been made pass through another filter, said another filter having a transmission peak at a specific wavelength different from said specific wavelength of said filter and having same after-pass noise intensity; and
calculating signal strength from output light intensity detected by said first detecting and said second detecting.

21. The optical signal detection method according to claim 20, wherein
said calculating comprises obtaining a difference between a plurality of pieces of strength of said detected optical signal or solving simultaneous equations having signal strength of a signal component of an optical signal as a variable.

22. The optical signal detection method according to claim 20, wherein said optical signal comprises a wavelength division multiplex signal.
